(19) United States
(12) Patent Application Publication
(10) Pub. No.: US 2015/0367493 A1
(43) Pub. Date: Dec. 24, 2015

(54) A GEARBOX FOR A POWER TOOL AND A POWER TOOL WITH SUCH A GEARBOX

(71) Applicant: TOMACTECH A/S, Lyngby (DK)

(72) Inventor: Troels Gottfried PEDERSEN, Nivå (DK)

(21) Appl. No.: 14/649,364

(22) PCT Filed: Dec. 3, 2013
(86) PCT No.: PCT/EP2013/075418

§ 371 Date: Jun. 3, 2015

(30) Foreign Application Priority Data
Dec. 3, 2012 (DK) PA 2012 00769
Feb. 7, 2013 (DK) PA 2013 70063

(51) Int. Cl. B25F 5/00; F16H 3/66

(52) U.S. Cl. CPC B25F 5/001; F16H 3/666; F16H 2200/2043

(57) ABSTRACT

The invention provides a power tool with an epicyclically gear system comprising: a frame attachable to, or forming, a chassis of the power tool, an output connectable to a tool end of the power tool, an input connectable to a motor, a first annulus ring (3) connected to the output and being rotatable about a main axis, a second annulus ring (2) locked or partly locked to the frame and being concentric with the main axis, a sun wheel (8) connected to the input of the gearbox and being rotatable about the main axis, a first set of planetary wheels (4) interacting with the first annulus ring and the sun wheel (8) and being fixed rotationally to a first carrier structure being rotatable about the main axis, at least one second set of planetary wheels (5), one set of the at least one second sets of planetary wheels interacting with the second annulus ring and with the sun wheel (8) and being fixed rotationally to a second carrier structure being rotatable about the main axis. To provide a simple gearbox which takes up less space, the first and second carrier structures, in a first mode, are connected to rotate with the same speed about the main axis.

### INTRODUCTION

The present invention relates to a gearbox for power tools such as power drills etc. The invention further relates to such a power tool including a gearbox and to a method of obtaining gearing in a power tool.

In particular, the invention relates to a power tool with a planetary gearbox and to the planetary gearbox as such and comprising:
a first annulus ring (3) connected to drive the tool end and being rotatable about a main axis,
a second annulus ring (2) locked or partly locked to the frame and being concentric with the main axis,
a sun wheel (8) driven by the motor and being rotatable about the main axis,
a first set of planetary wheels (4) interacting with the first annulus ring and the sun wheel (8) and being fixed rotationally to a first carrier structure which is rotatable about the main axis, and
at least one second set of planetary wheels, one set of the at least one second sets of planetary wheels interacting with the second annulus ring and with the sun wheel and being fixed rotationally to a second carrier structure being rotatable about the main axis.

### BACKGROUND OF THE INVENTION

Gearboxes has been around for ages, and in particular used in hand held power tools of various kinds.

Hand operated power tools generally have a motor, typically an electrical motor, and a transmission which converts the high speed low torque motor output into a low speed high torque input for the tool. Typically, the design criteria relates to low manufacturing costs in combination with low weight, zero maintenance and a lifetime in the range of 1000-10000 operating hours. Particularly in combination with power drills and other low weight hand operated power tools, a further design criterion is to reduce the distance between the motor and the tool to thereby provide a compact power tool.

Planetary gearboxes are often used in power tools and particular in compact power drills that are cordless. The planetary gearbox is known for its compactness and for its multiple gearwheels which share the load when transferring and transforming mechanical power from an electric motor into e.g. a high torque output of the drill.

As a power drill must fulfil different jobs—there are generally two or more gearbox settings providing different torque/speed conversion ratios in the gearbox. The settings are selectable on a gear shift on the outside of the chassis such that the user can manually select a suitable setting.

One setting typically provides a mid-reduction of motor speed (e.g. 1:16) having only a minor torque available but high speed. Another setting is typically a high reduction (e.g. 1:60) of the motor speed giving a very high torque but slow speed of the tool.

Each of the two settings is used for different purposes. The high speed mode is used for drilling small holes and screwing small screws into e.g. wood. Having the high speed available helps the worker to increase performance. The low speed mode is used for drilling big holes and whenever a high torque is needed. Having this mode allows for the user or worker to fulfil difficult jobs requiring the high torque, even though it may take longer to finish the job.

In many professional power drills, even more settings are provided for the user to get exactly the speed and torque needed to fulfil a job.

Traditionally, such a gearbox is made by connecting three independent planetary gearboxes serially, so that the output from the first is input of the next etc. This is referred to as multistage planet gearboxes. By short circuiting one of the planetary stages, e.g. by connecting the output of stage number 1 directly to the input of stage number 3, it is simple to change gear-ratio. The desire for three or even four settings and thus stages complicates the construction and is typically difficult to meet. The reason is that more stages introduce a complicated short circuiting structure and the choice of speeds are related to the different gear ratio in each stage and not freely chosen, due to physical dimensions and the structure where each stage is serially connected to the next. Consequently the complexity and size may be undesirably high for such gear systems.

In addition, multistage planet gearboxes are normally quite complex having a large number of parts to be assembled and quality is quite demanding as many parts are stacked up inside the gearbox.

Some of the important properties or desires for new gearboxes within power tools—includes small size, low weight and low cost. In addition robustness and reliability is important, but this is in general handled by fulfilling tests and requirements made by the manufacture. E.g. increasing robustness by adding more material and redesigning critical components Consequently, a benchmarking of new concepts for gearboxes includes considerations on size, weight and cost—given that it is believed that a required reliability and robustness is possible to achieve and that the manufacturing of such a concept is possible.

In the search for such smart gearboxes there have been many different proposals. Recently, focus has been on compound gearboxes such as the ones mentioned in patent application WO2011135076 in which the locking of planet carrier with respect to a compound gear gives a change in gear ratio. In another patent application WO2006102906, a compound gear is described changing gear ratio by use of coupling different sun wheels to the input, or by locking different annulus rings. Both of the mentioned gear are significant different from that of a traditional planetary gearbox in that the output is connected to one annulus ring instead of the planet carrier which is the common way of using a planetary gear.

The compound gear described above, introduces some major advantages. One advantage is that the compound offers a very high gear ratio in one single stage. At least for medium high gear ratios this is not in conflict with having a high or reasonable efficiency. Even though the compound gears described in the mentioned patents have to have two annulus rings—one for the output, and one for the reference—both carrying the maximum torque, it is still believed that much space and complexity can be saved e.g. making a gear ration of 1:60. In particular integrating the two segments of the planet wheels offers the manufacture to produce only one type of planet wheel that may interact with both annulus rings.

Thus this is also a limitation in the compound gear. The compound gear described in the patents referred to, have to have the functionality where the two segments of the planet wheels are joined rotationally to transfer torque. If this is not fulfilled the gearbox will not work. The two segments must therefore be placed on the same axis which limits the design possibilities.

Further, the nature of the described compound gearbox is so that if smaller gear ratios are desired, the difference in size of the two segments of the planet wheel must be large. The result is that one of the annulus rings will be considerable smaller than the other. As a result, the overall dimension of the smallest annulus ring must be bigger than that of the other as they are subjected to almost the same torque measured on the centre axis of the gearbox.

It is already known that a planetary gearbox may serve as a differential gearbox in which the output is formed by having two inputs e.g. one on the sun-wheel and another on the planetary carrier. In this case the output is on the annulus ring.

### DESCRIPTION OF THE INVENTION

It is the object of this invention to create a concept for a simple and reliable differential gearbox that takes up less space and is easier to manufacture than ordinary stacked planet gearboxes.

According to this object, the invention provides a power tool according to claim 1 and a gearbox for a power tool according to claim 2. Due to the connection of the first and second carrier structures, the gearbox may take up less space and is easier to manufacture than ordinary stacked planet gearboxes.

According to the invention, the first and second carrier structures are connected or they are connectable such that they rotate with the same speed about the main axis. The first and second carrier structure may be constituted by the same element, i.e. they may be formed integrally in one and the same unit, or they may form two different structures which are connected such that they rotate with the same speed. Accordingly, the first carrier structure is simply that entity holding the planetary wheels of the first set of planetary wheels for epicyclic rotation about the main axis and the second carrier structure is simply that entity holding the planetary wheels of the second set of planetary wheels for epicyclic rotation about the main axis.

For a simple planetary gearbox having a fixed carrier and input on the sun wheel, the speed of the output, i.e. the speed of the annulus ring is simply the inverse of the relationship between the number of teeth on the annulus ring Zₐ and the number of teeth on the sun wheel Zₛ. The output speed n₁ may be found as:

$${n}_{1} = - {n}_{in 1} \frac{{Z}_{s}}{{Z}_{a}}$$

Unlocking the carrier structure and adding a differential speed nᵢₙ₂ this, gives us the equation for the output nₒᵤₜ of the gearbox:

$${n}_{out} = - {n}_{in 1} \frac{{Z}_{s}}{{Z}_{a}} + {n}_{in 2} ( 1 + \frac{{Z}_{a}}{{Z}_{s}} )$$

If the nᵢₙ₂ input is generated by a traditional planetary pre-stage—also driven by the input nᵢₙ₁—we find the relationship of nᵢₙ₂ and nᵢₙ₁ in the pre-stage:

$${n}_{in 2} = \frac{{n}_{in 1}}{( 1 + \frac{{Z}_{a 2}}{{Z}_{s 2}} )}$$

In this the Zₐ₂ is the number of teeth on the annulus-ring in the pre-stage, and similar Zₛ₂ refers to the number of teeth on the sun wheel of the pre-stage.

In combination with the previously we find:

$${n}_{out} = - {n}_{in 1} \frac{{Z}_{a}}{{Z}_{s}} + ( \frac{{n}_{in 1}}{( 1 + \frac{{Z}_{a 2}}{{Z}_{s 2}} )} ) ( 1 + \frac{{Z}_{s}}{{Z}_{a}} )$$

If the annulus rings and the sun wheels are of almost same diameter, we get a very high gear ratio. For practical usage, such high ratios are not always desirable , since the differential gearbox produces ‘power circulation’ which is power that is circulated internally without being used on the output.

For a power tool e.g. a power drill it is however interesting to use, as the gear ratio of such a device is typically within the range of 1:40 having only one gear ratio, and 1:16/1:60 having two gear ratios.

In particular, it is of interest to use this type of gearbox which is different from the compound gearbox introduced in the ‘background of the invention’. As mentioned there, the challenge having smaller gear ratios is that due to the nature of the compound gearbox, one of the segments on the planet wheel must be smaller than the other in order to achieve medium or low gear ratios. As a result, one of the two annulus rings must in similar ways be small. This can be a challenge with respect to strength of the gearbox.

As an example, designing a compound gearbox with 1:16 in gear ratio demands that one of the segments on the planet wheel is almost half the diameter than that of the other. This leads to more stress of the teeth in this part of the compound gearbox and more material must be added. One way could be to introduce additional planet wheels—as these are small. But this is not feasible as the smaller segments of the planet wheels must be joined rotationally with the others having almost twice the diameter. Consequently the only way to achieve more strength is by increasing the width of the smaller segments of the planet wheel. And by that—also the width of the annulus ring.

However using the principle of summarizing movements allows a much more freely design.

Firstly, as the summarizing gearbox does not dictates that the two planet segments are joined rotationally. On the contrary this is not allowed as each of the two segments is driven by different sun wheels. The result is that even though smaller gear ratios are desired, this can be done without having major differences in diameter on the annulus rings.

In addition it is possible to design each of the two stages—the summarizing stage and the reference stage—so that each segment of the planet wheel does not have to share rotational axis. In fact one must regard the two segments as individually planet wheels that may be fixed freely rotationally in each stage. As long as the carrier structure of the two stages are joined to transfer movement.

For such purposes it is found that the losses due to the circulation of power can be held at a level similar to that of a two- and three stage planetary gearbox.

The planetary gearbox may form an integrated part of a power tool such as a power drill, a sander, a grinder, or any similar kind of power tool

The frame may be attachable to, or forming, a chassis of the power tool. In one embodiment, the frame is an integrated part of the motor for the power tool, or it comprises a coupling for attaching the gearbox to the motor. The output is connectable to a tool end of the power tool or it is integrally formed as a tool end. By tool end is herein meant an element which can receive, or which forms, an end effector, i.e. a tool or similar object, e.g. an element for receiving a screw-bit or a drill.

Herein, an annulus ring, is a ring which is driven along an internal rim surface. Typically the annulus ring is a gear ring with internal toothing for engagement with a tooth wheel. The gear box forms a main axis, and the annulus rings are both rotatable about that main axis.

The first annulus ring is connected to, or forms, the output of the gearbox. I.e. the first annulus is directly driving the output or even the tool end with the identical rpm (rounds per minute).

The second annulus ring is locked or partly locked to the frame and it is rotatable about the main axis. By partly locked is herein meant that it can rotate but rotation is limited such that a threshold torque must be exceeded before the ring starts to rotate.

The sun wheel is connected to the input of the gearbox and being rotatable about the main axis. Typically, the sun wheel is directly connected to the motor and therefore rotates with the same rpm as the motor.

The first set of planetary wheels interacts with the first annulus ring. Herein “interact” means that the first set of planetary wheels rolls along the inner surface of the first annulus ring. Typically the first set of planetary wheels are tooth wheels engaging in an inner toothing of the first annulus ring. The planetary wheels of the first set of planetary wheels further interact with the sun wheel.

The planetary wheels of the first set of planetary wheels are fixed rotationally to a first carrier structure which can rotate about the main axis. Herein, “fixed rotationally” means that the planetary wheels can each rotate about its own centre axis which is offset from the main axis. The wheels thereby rotate epicentrically.

The at least one set of the second set of planetary wheels comprises at least one set of wheels which interacts with the second annulus ring and with the sun wheel. The planetary wheels of the second set of planetary wheels are fixed rotationally to a second carrier structure which can rotate about the main axis. Again, “fixed rotationally” means that the planetary wheels can each rotate about its own centre axis which is offset from the main axis. The wheels thereby rotate epicentrically.

The first set of planetary wheels may have a larger working diameter than at least one set of the second sets of planetary wheels.

The first set of planetary wheels may have a smaller working diameter than at least one set of the second sets of planetary wheels.

The first and second carrier structures may be formed in one part. Particularly, the first and second carrier structures may be made in a monolithic element. In this embodiment, the planetary wheels of the first set of planetary wheels may rotate about individual axes being parallel with or forming extension of corresponding rotation axes of the planetary wheels of the second set of planetary wheels.

The gearbox may comprise a first switching means which selectively can engage the frame and the second annulus ring to thereby lock or at least partly lock the second annulus ring to the frame.

The gearbox may comprise a second switching means which selectively can engage one of the first and second carrier structures and the second annulus ring to thereby lock or at least partly lock the second annulus ring to the carrier structure.

The gearbox may comprise at least one additional annulus ring interacting with an additional set of the second sets of planetary wheels.

The gearbox may comprise a third switching means which selectively can engage one of the additional annulus rings and the frame to thereby lock or at least partly lock the additional annulus rings to the frame.

The gearbox may comprise a fourth switching means which selectively can engage one of the first and second planetary carrier structures and the frame to thereby lock or at least partly lock the carrier structure to the frame.

The gearbox may comprise a fifth switching means which are arranged to move the second annulus ring between a first position where it interacts with one set of the second sets of planetary wheels and a second position where it interacts with another set of the second sets of planetary wheels.

The planetary wheels of the first set of planetary wheels may overlap at least some of the planetary wheels of the second set of planetary wheels in the direction of the main axis. This feature may facilitate a very short construction in the direction of the main axis. The feature may particularly be available in the aforementioned embodiment where the first and second carrier structures are formed in one part.

The planetary wheels of the first set of planetary wheels may rotate about planetary axes of a first group having a first distance to the main axis and the planetary wheels of the second set of planetary wheels rotate about planetary axes of a second group having a second distance to the main axis. The first and second distance may be identical, and each axis of the first group may be coaxial with one axis of the second group. In this way, one planetary axis of the first group may be formed in one piece with one planetary axis of the second group.

In this embodiment, the axes may be formed e.g. as combining rod or similar bearing structure, herein referred to simply as rod, where one end of the rods forms an axis of the first group and the other end of the rods forms an axis of the second group. In one embodiment, the first and second carrier structures are combined into one single element. In this embodiment, the rods may extend through a single carrier element and form bearings on opposite sides of the combined carrier element. In another embodiment, one element forms the first carrier structure and another element forms the second carrier structures, and the combining rods extends through both elements, thereby ensuring rotation of the first and second carrier structures with same speed about the main axis.

In another embodiment, the planetary axes of the first group are angular offset from the planetary axes of the second group. I.e. the axes are not coaxial. This enables a more compact gearbox and power tool, particularly by providing an axial overlap between the planetary wheels in the first group and the planetary wheels in the second group. By angular offset is meant that the axes are not along the same radial direction from the main axis.

### LIST OF DRAWINGS

In the following, the invention will be described in further details with reference to embodiments and with reference to the drawings in which:

FIGS. 1-5 illustrate different embodiments of gearboxes according to the invention with two separate carrier structures which are joined;

FIGS. 6-7 5 illustrate different embodiments of gearboxes according to the invention with a combined carrier structures forming the first and second carrier structures in one piece; and

FIG. 8 illustrates a gearwheel with two segments.

It should be understood that the detailed description and specific examples, while indicating embodiments of the invention, are given by way of illustration only, since various changes and modifications within the spirit and scope of the invention will become apparent to those skilled in the art from the detailed description.

### DETAILED DESCRIPTION

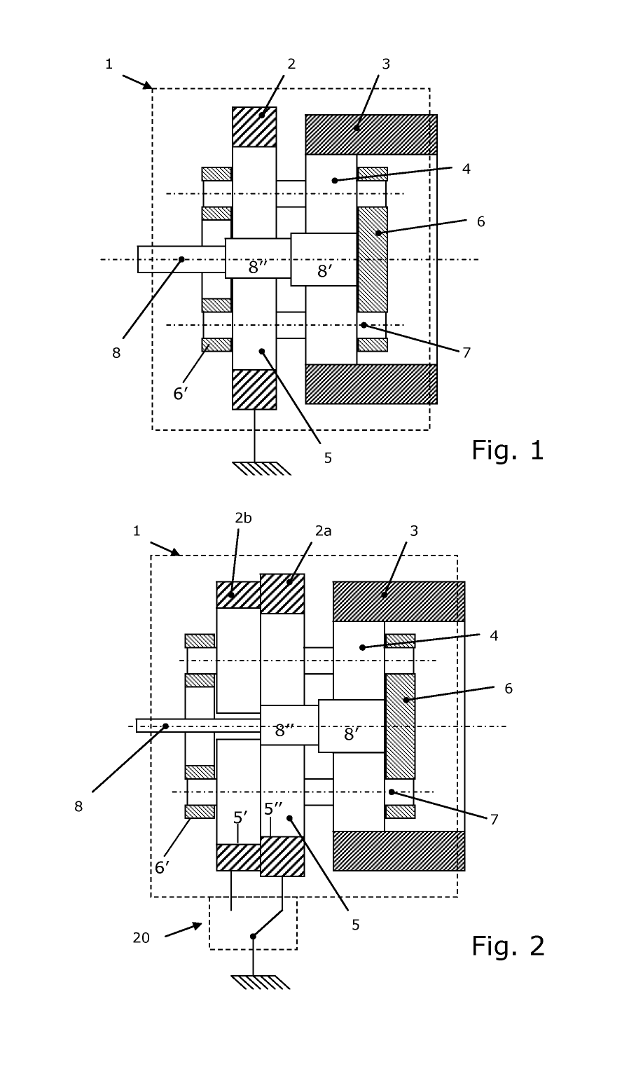

FIG. 1 shows one embodiment of the invention. The gearbox 1 is fixed or integral with a power tool that may also form an enclosure for the gearbox. The gearbox comprises a first annulus ring 3 connected to the output of the gearbox. The annulus ring 3 has an internal toothing and is meshing with external toothing on one first set of planetary wheels 4.

The planetary wheels are arranged to rotate epicentrically about the main axis. For this purpose, they are attached to rotational bearings located epicentrically about the main axis, herein, this is referred to as being fixed rotationally to a carrier structure 6. The planetary wheels 4 are also meshing with one wheel segment 8′ of the sun wheel 8.

The sun wheel 8 forms the wheel segments 8′ and 8″ and a shaft which is connected to, or forms the input of the gearbox. Both wheel segments are fixed to and rotates with the shaft, i.e. they rotate with the same rotational speed as the input.

The wheel segments 8′ and 8″ have different pitch diameter. As one segment 8′ interacts with one first set of planetary wheels 4, the other segment 8″ is intersecting with one second set of planetary wheels 5.

The second set of planetary wheels 5 is fixed rotationally in a carrier structure 6′, again such that they can rotate epicentrically about the main axis. Additionally, they mesh with one secondary annulus ring 2. The secondary annulus ring 2 is locked to the frame of the system 1 or partly locked to the frame. Being partly locked to the frame implies that during certain conditions the locking is released.

Such conditions may be that whenever certain levels of torque is acting on the annulus ring 2, the annulus ring is able to slide or being released from locking—in order to avoid e.g. overstress of the components inside the gearbox or components attached to the input or output of the gearbox. Other conditions may be release of locking during corrections of position of the output in order for the power tool to e.g. follow certain positions on the output with respect to time.

In an embodiment of the invention, the planetary wheels 4 and 5 are fixed rotational to the same carrier structure 6, and maybe even be using the same axle 7 for bearing. The sets of planet wheels 4 and 5 may also be fixed rotational in two individual carrier structures 6, 6′—connected to transfer torque and such that they two carrier structures rotate with identical speed. This configuration could help reducing the over-constraints of the system, as the two carrier structures may position themselves to help each of the sets of planet wheels 4 and 5 to have optimized load distribution.

As the output speed and direction of rotation depends very much on the differential conditions of the gearbox, it is not secondary how the system is configured. Having a large gear-ratio e.g. 1:40 in one gear stage it is important to secure that the internal losses are kept minimal during operation. Major losses in gearboxes are usual connected to frictional (viscous) losses during high speed. Thus, it may be an advantage to keep e.g. the planetary wheels at the lowest possible speed.

Another important issue is the output of rotation. If one consider the stage comprising the first annulus ring as the differential stage—reducing the input speed is done by adding a movement on the carrier structure. If the carrier is held still—without movement—the orientation of movement of the first annulus ring is opposite the sun-wheel. Slowly adding speed to the carrier structure (in the same direction as the input) reduces the output speed of the first annulus. At one speed of the carrier the desired reduction is reached but still having a rotation opposite of the input. If one keeps on adding speed to the carrier—the speed is continuously reduced—until the first annulus ring stops turning. Adding even more speed to the carrier results in increased speed of the annulus ring, but now in the same direction as the sun wheel. Thus two different speeds of the carrier will give the desired output speed of the gearbox—but with opposite direction of rotation.

If the planet wheels 4 have a larger diameter than the planet wheels 5 being mounted on the same rotational axle 7, it is possible to have a direction of rotation on the output of the gearbox identical to the direction of rotation on the input of the gearbox.

In FIG. 2 another embodiment is illustrated. In this embodiment the second set of planetary wheels 5 comprises two sections with different pitch diameter 5′, 5″. The sections are joined to form one gearwheel. Either they are joined by mechanical interaction allowing for transfer of torque, or they are formed in one piece of e.g. metal or plastic.

Each of the sections interacts with one secondary annulus ring 2b and 2a. Each of the two annulus rings 2a and 2b may be locked to the frame simultaneously or one at a time. The locking may be rigid or it may be partly giving the annulus ring a possible movement to adapt tolerances or to slide.

In addition the embodiment comprises selection means 20 which allows to choose which of the two annulus rings 2a and 2b that is locked or partly locked to the frame.

One of the sections 5′, 5″ in the planetary wheel 5 is also interacting with sun wheel 8.

The planetary gearbox formed by the annulus rings 2a and 2b, the planetary wheel 5 and the sun wheel 8 produces an output movement of that carrier 6, 6′ to which the planet wheels 5 are rotational fixed. This movement of the carrier 6, 6′ is summarised with the movement of the sun wheel 8 interaction with the first set of planetary wheels 4. The resulting movement is rotation of the annulus ring 3, that forms an output of the gearbox, and which is integral or connected to an output shaft of the gearbox or power tool.

Planetary wheel 5 with at least two segments having different pitch diameter, allows change of speed of the output of the gearbox. In the design of normal compound gearboxes, the difference in diameter on a planet wheel with multiple sections may be quite large to thereby achieve a significant change in gear ratio, the differential gearbox may work with much less difference in diameter of the secondary planet wheels.

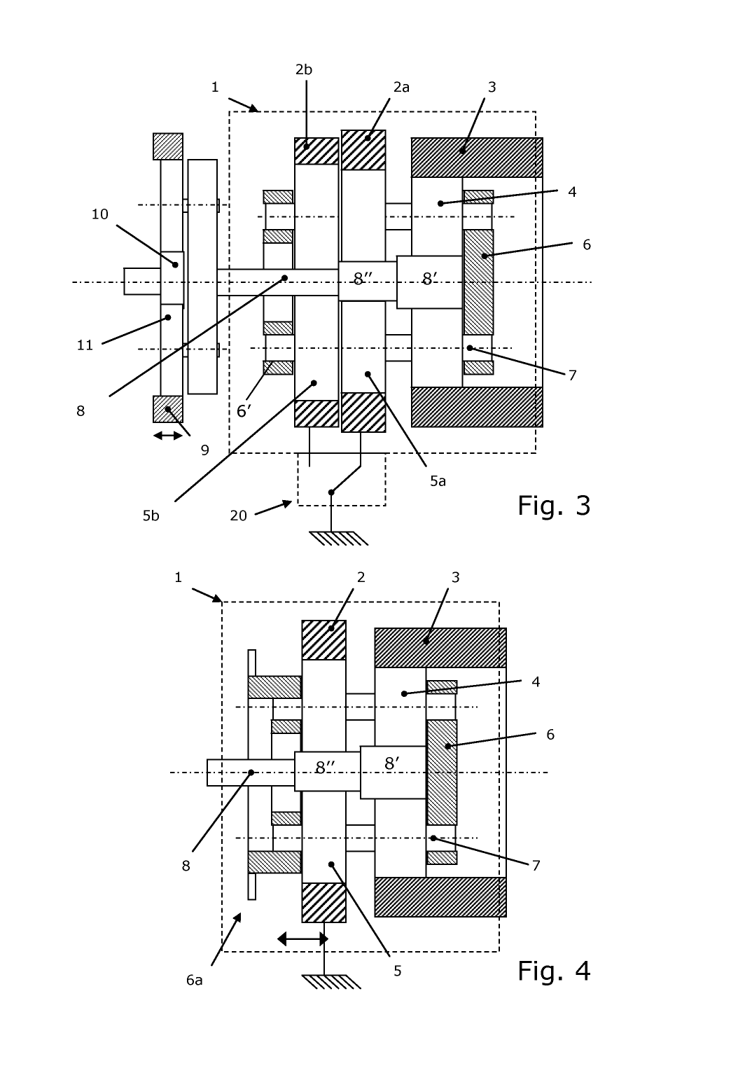

FIG. 3 shows yet another embodiment of the invention. Similar to the embodiment shown in FIG. 2, the embodiment in FIG. 3 comprises two secondary annulus rings 2a and 2b, each interacts with two sets of planetary wheels 5a and 5b. Each of these planetary wheels interact with the sun wheel 8 to form two separate planetary gears in which the planetary wheels 5a and 5b are rotational fixed to the same carrier 6). Further the system comprises switching means 20 allowing the locking of either of the two annulus rings 2a or 2b to the frame of the gearbox or power tool. As the two individually planet gears have different gear ratio depending on the size of the different wheels, it is possible to switch speed of the carrier structure by choosing which of the two annulus rings 2a or 2b that are locked to the frame of the gearbox.

As in the other embodiments, the output of the two individually planet gears controls the speed of the carrier, which also holds the primary set of planetary wheels 4. As the planetary wheels 4 are also interacting with the sun wheel 8, the resulting rotation of the annulus ring 3 is a combined or summarised rotation.

In addition, FIG. 3 shows how the gearbox may be fitted with a post-gearing—formed by the planetary gear, comprising an annulus ring 9, a set of planetary wheels 11 and a sun wheel 11. The carrier of the planetary wheels is formed integral with the sun wheel 8, but could also be a separate component that is attached to the sun wheel 8.

In FIG. 4, another embodiment is seen. This embodiment differs from the previous embodiments by enabling the annulus ring 2 to slide out of meshing with the set of planetary wheels 5 in one position, and instead mesh with the carrier structure 6 in another position. The result is that during this second position of the annulus ring, the gear is transformed into an ordinary planet gear with output of the annulus ring 3 input on the sun wheel 8 and stationary planetary wheels 4 fixed rotationally to the carrier 6. In the first position of the annulus ring 2, the gearbox still acts as a differential planetary gearbox. In order for the gearbox to deliver a direction of output that is the same in both positions of the annulus ring, the planet wheel 4 needs to have smaller size—pitch diameter—than the planet wheel 5. As the gearbox in FIG. 4 will reverse the output in comparison with input whenever the annulus ring 2 is meshing with planetary carrier 6, it is desirable that output of the gearbox is also reversing the output in comparison to the input whenever the annulus ring 2 is meshing with the planet wheel 5.

As most motors used for power tools have more torque in one direction of rotation than in the other it is not desirable that the gearbox has different direction of rotation in the two positions of the annulus ring 2.

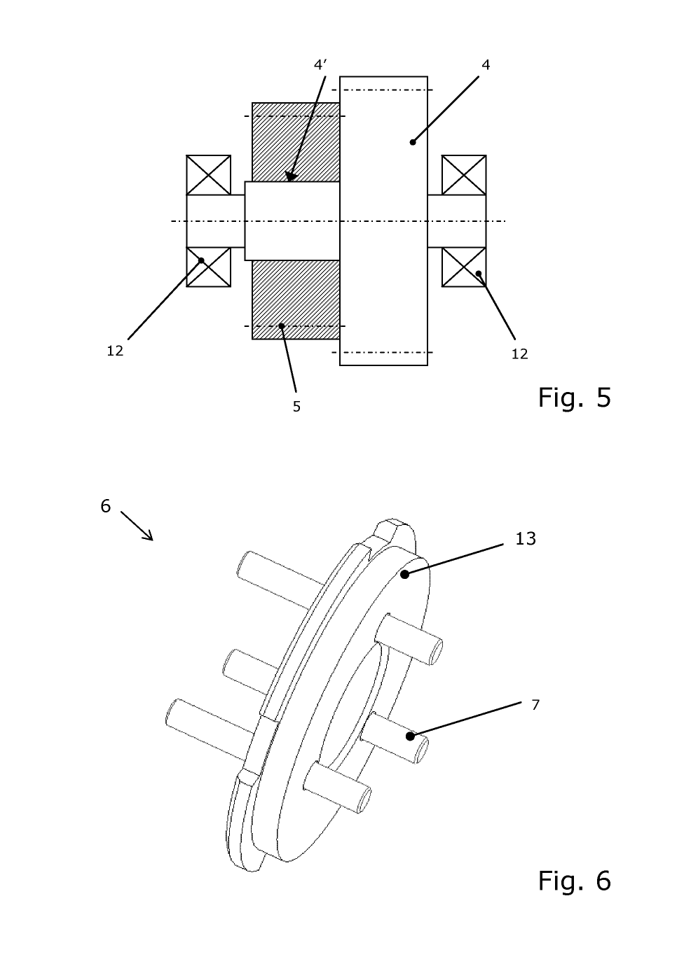

FIG. 5 shows a subassembly in one of the embodiments of the gearbox. The planetary gearwheel 4 may have extremities such as 4′, which may form a bearing of the planet wheel 5. The planet wheel 4) is fixed rotational into the carrier 6 (not shown) by two bearings 12. This design may help to reduce friction of the system, as torque transferred between the two planet wheels will be tangential forces.

In the previously shown embodiments, each planet wheel had to transfer torque through the axle 7, which is expected to be rotational locked to carrier, and therefore not moving. Thus—in the previous embodiments of FIG. 1, 2, 3 and FIG. 4, the speed difference in the bearings of 5 and 7 and 4 and 7 is much higher than in the one shown in FIG. 5. Consequently the friction losses may be reduced. Even though the surface 4′ is shown as integral of 4 the surface 4′ may also be formed by e.g. another piece of material attached to the gearwheel 4.

As an example the working diameter or pitch diameter of the planetary gearwheel 4 is larger than that of planetary wheel 5. This is opposite in the previously shown embodiments. Though, this configuration helps to secure that direction of the output is the same as the input. This will be important in e.g. power drills where the gearbox replaces ordinary multistage gearboxes without changing e.g. the motor. In these power drills the motor can have more torque in one direction than another allowing a higher torque when mounting a screw. Keeping the same direction of rotation on the output as on the input of the gearbox makes it possible to replace the ordinary multistage planet gearbox that normally have this feature.

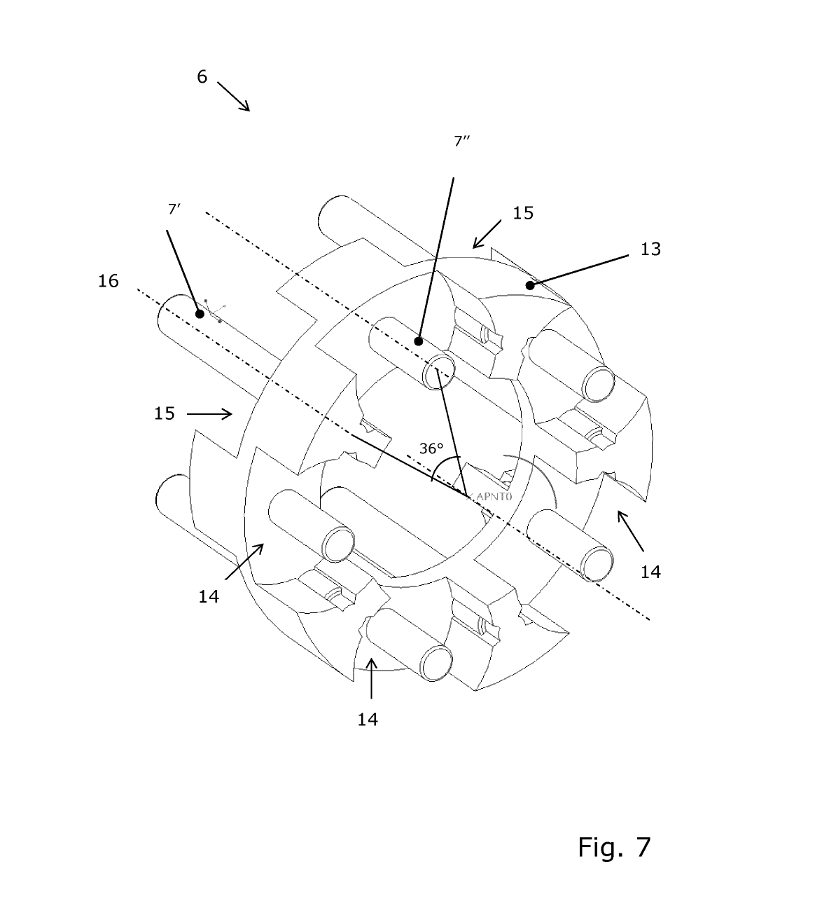

FIGS. 6 and 7 illustrate embodiments of a combined carrier structure, i.e. embodiments where the first and second carrier structures are formed in one part.

In FIG. 6, the carrier 6 comprises axles 7 which extend through the carrier body 13. The axles therefore define bearings on opposite sides of the carrier body 13. This enables the planetary wheels of the first set of planetary wheels to be mounted on one side of the carrier body, and the planetary wheels of the second set of planetary wheels to be mounted on the opposite side of the carrier body. The combined carrier structure therefore constitutes the first and second carrier structures formed in one piece.

In FIG. 7, the carrier 6 comprises axles 7′ which extend outwards from one surface of the carrier body 13 and axles 7″ which extend outwards from an opposite surface of the carrier body 13. The axles 7′ and 7″ are attached to the carrier body at different circumferentially spaced locations, i.e. they are angularly offset such that the axles 7′ are not coaxial with the axles 7″. In the embodiment of FIG. 7, the angular offset is 36 degrees but it could be other values, e.g. 60 degrees offset which would provide symmetry with three axles on both sides of the carrier body 13. The axles thereby define non-coaxial bearings on opposite sides of the carrier body 13. This enables the planetary wheels of the first set of planetary wheels to be recessed in the depressions 14 and the planetary wheels of the second set of planetary wheels to be recessed in the depressions 15. As a result thereof, the thickness of the carrier 6 in the direction of the main axis 16 can be reduced, and the entire gearbox or power tool can be made with a reduced dimension.

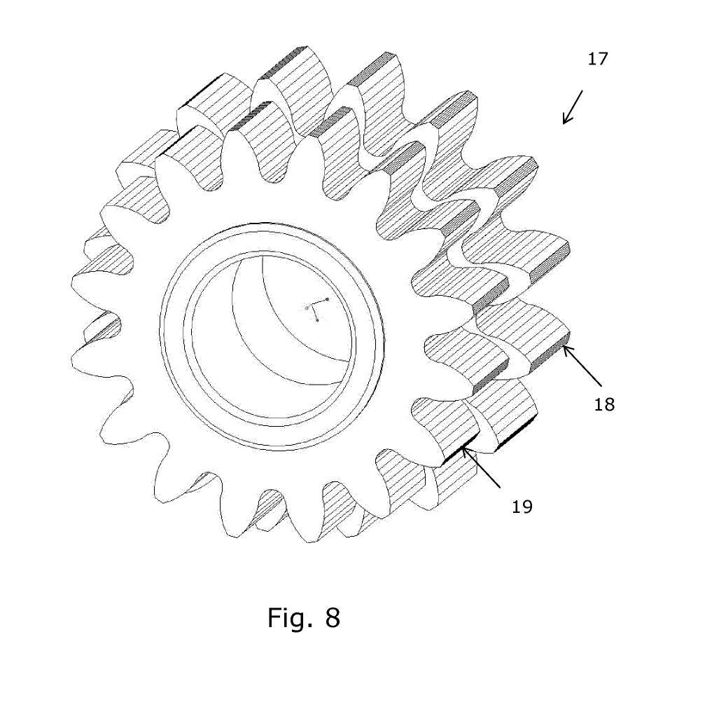

FIG. 8 illustrates a gearwheel 17, with two toothed segments 18, 19 where the segments have equal number of teeth but different diameter. The modulus can be the same or it can be different. The illustrated gearwheel 17 can constitute e.g. the sun wheel 8, c.f. FIG. 1-4, i.e. the segments 18, 19 can constitute the segments 8′ and 8″. The gearwheel 17 can also constitute the planetary wheels 5 which may comprise two sections with different pitch diameter 5′, 5″, c.f. FIG. 2. The gearwheel, due to the identical number of teeth, facilitates manufacturing e.g. by moulding, e.g. metal injection moulding, or by sintering etc.

### EMBODIMENTS

1. A planetary gearbox 1) for a power tool comprising:
a frame attachable to, or forming, a chassis of the power tool,
an output connectable to a tool end of the power tool,
an input connectable to a motor,
a first annulus ring (3) connected to the output and being rotatable about a main axis,
a second annulus ring 2) locked or partly locked to the frame and being concentric with the main axis,
a sun wheel (8) connected to the input of the gearbox and being rotatable about the main axis,
a first set of planetary wheels 4) interacting with the first annulus ring and the sun wheel 8) and being fixed rotationally to a first carrier structure being rotatable about the main axis,
at least one second set of planetary wheels 5), one set of the at least one second sets of planetary wheels interacting with the second annulus ring and with the sun wheel 8) and being fixed rotationally to a second carrier structure being rotatable about the main axis,

characterised in that the first and second carrier structures, in a first mode, are connected to or connectable to rotate with the same speed about the main axis.

Embodiment 2. A planetary gearbox according to Embodiment 1, wherein the first set of planetary wheels has a larger working diameter than at least one set of the second sets of planetary wheels.

Embodiment 3. A planetary gearbox according to embodiment 1, wherein the first set of planetary wheels has a smaller working diameter than at least one set of the second sets of planetary wheels.

Embodiment 4. A planetary gearbox according to any of the preceding embodiments, wherein the first and second carrier structures are formed in one part.

Embodiment 5. A planetary gearbox according to any of the preceding embodiments, comprising a first switching means which selectively can engage the frame and the second annulus ring to thereby lock or at least partly lock the second annulus ring to the frame.

Embodiment 6. A planetary gearbox according to any of the preceding embodiments, comprising a second switching means which selectively can engage one of the first and second carrier structures and the second annulus ring to thereby lock or at least partly lock the second annulus ring to the carrier structure.

Embodiment 7. A planetary gearbox according to any of the preceding embodiments, comprising at least one additional annulus ring interacting with an additional set of the second sets of planetary wheels.

Embodiment 8. A planetary gearbox according to embodiment 7, comprising a third switching means which selectively can engage one of the additional annulus rings and the frame to thereby lock or at least partly lock the additional annulus rings to the frame.

Embodiment 9. A planetary gearbox according to any of the preceding embodiments, comprising a fourth switching means which selectively can engage one of the first and second planetary carrier structures and the frame to thereby lock or at least partly lock the carrier structure to the frame.

Embodiment 10. A planetary gearbox according to any of the preceding embodiments, comprising a fifth switching means which are arranged to move the second annulus ring between a first position where it interacts with one set of the second sets of planetary wheels and a second position where it interacts with another set of the second sets of planetary wheels.

Embodiment 11. A planetary gearbox according to any of the preceding embodiments, comprising sets of the second sets of planetary wheels having a working diameter being different from a working diameter of another set of the second sets of planetary wheels.

Embodiment 12. A planetary gearbox according to embodiment 11, where each planetary wheel of one set of the second sets of planetary wheels is connected to a planetary wheel of another set of the second sets of planetary wheels to enable transfer of torque between the connected planetary wheels.

Embodiment 13. A planetary gearbox according to all previous embodiments, wherein the gearbox is coupled to another gearbox on the input or on the output.

Embodiment 14. A planetary gearbox according to all previous embodiments, wherein each annulus ring, sun wheel and planetary wheel comprises gear teeth meshing with gear teeth of at least one other wheel.

Embodiment 15. A planetary gearbox according to embodiment 1 to embodiment 13, wherein each annulus ring, sun wheel and planetary wheel transfer forces magnetically or by traction/friction to at least one other wheel.

Embodiment 16. A planetary gearbox according to any of the preceding embodiments, where the second annulus ring is connected to the frame by a coupling which allows movement of the second annulus ring relative to the frame but which at least partly or completely prevents rotation of the second annulus ring.

Embodiment 17. A planetary gearbox according to all previous embodiments in which a planetary wheel of the first set of planetary wheels and planetary wheels of the second set of planetary wheels are rotational about a common axle 7)

Embodiment 18. A planetary gearbox according to embodiment 17, where the common axle forms part of, or is integral with, one of the planetary wheels.

Embodiment 19. A method of operating a planetary gearbox according to any of embodiments 5-x, where at least one of the switching means are operated to cause a change of direction and speed of the rotation of the output.

1. A power tool with a frame, a motor attached in the frame, a tool end for attachment of, or forming an end effector, and a planetary gearbox connecting the motor to the tool end, the planetary gearbox (1) comprising:
a first annulus ring (3) connected to drive the tool end and being rotatable about a main axis,
a second annulus ring (2) locked or partly locked to the frame and being concentric with the main axis,
a sun wheel (8) driven by the motor and being rotatable about the main axis,
a first set of planetary wheels (4) interacting with the first annulus ring and the sun wheel (8) and being fixed rotationally to a first carrier structure which is rotatable about the main axis,
at least one second set of planetary wheels (5), one set of the at least one second sets of planetary wheels interacting with the second annulus ring and with the sun wheel (8) and being fixed rotationally to a second carrier structure which is rotatable about the main axis,
characterised in that the first and second carrier structures are connected to rotate with the same speed about the main axis.

2. A planetary gearbox (1) for a power tool comprising:
a frame attachable to the power tool,
an output connectable to a tool end of the power tool,
an input connectable to a motor,
a first annulus ring (3) connected to drive the output and being rotatable about a main axis,
a second annulus ring (2) locked or partly locked to the frame and being concentric with the main axis,
a sun wheel (8) connected to be driven by the input of the gearbox and being rotatable about the main axis,
a first set of planetary wheels (4) interacting with the first annulus ring and the sun wheel (8) and being fixed rotationally to a first carrier structure being rotatable about the main axis,
at least one second set of planetary wheels (5), one set of the at least one second sets of planetary wheels interacting with the second annulus ring and with the sun wheel (8) and being fixed rotationally to a second carrier structure being rotatable about the main axis,
characterised in that the first and second carrier structures are connected to rotate with the same speed about the main axis.

3. A tool or a planetary gearbox according to claim 1, wherein the first set of planetary wheels has a larger working diameter than at least one set of the second sets of planetary wheels.

4. A tool or a planetary gearbox according to claim 1, wherein the first set of planetary wheels has a smaller working diameter than at least one set of the second sets of planetary wheels.

5. A tool or a planetary gearbox according to 1, wherein the first and second carrier structures are formed in one part.

6. A tool or a planetary gearbox according to claim 1, comprising a first switching means which in a first position can lock the second annulus ring to the frame and in a second position, releases the second annulus ring from the frame.

7. A tool or a planetary gearbox according to claim 1, comprising a second switching means which selectively can engage one of the first and second carrier structures and the second annulus ring to thereby lock or at least partly lock the second annulus ring to the carrier structure.

8. A tool or a planetary gearbox according to claim 1, comprising at least one additional annulus ring interacting with an additional set of the second sets of planetary wheels.

9. A tool or a planetary gearbox according to claim 8, comprising a third switching means which selectively can engage one of the additional annulus rings and the frame to thereby lock or at least partly lock the additional annulus rings to the frame.

10. A tool or a planetary gearbox according to claim 1, comprising a fourth switching means which selectively can engage one of the first and second planetary carrier structures and the frame to thereby lock or at least partly lock the carrier structures to the frame.

11. A tool or a planetary gearbox according to claim 1, comprising a fifth switching means which are arranged to move the second annulus ring between a first position where it interacts with one set of the second sets of planetary wheels and a second position where it interacts with another set of the second sets of planetary wheels.

12. A tool or a planetary gearbox according to claim 11, where the planetary wheels of the first set of planetary wheels overlap at least some of the planetary wheels of the second set of planetary wheels in the direction of the main axis.

13. A tool or a planetary gearbox according to claim 1, where the planetary wheels of the first set of planetary wheels rotate about planetary axes of a first group having a first distance to the main axis and the planetary wheels of the second set of planetary wheels rotate about planetary axes of a second group having a second distance to the main axis.

14. A tool or a planetary gearbox according to claim 13, where the first and second distance are identical.

15. A tool or a planetary gearbox according to claim 13, where the planetary axes of the first group are coaxial with the planetary axes of the second group.

16. A tool or a planetary gearbox according to claim 13, where the planetary axes of the first group is angular offset from the planetary axes of the second group.
